(19) United States
(12) Patent Application Publication
(10) Pub. No.: US 2013/0027562 A1
(43) Pub. Date: Jan. 31, 2013

(54) SYSTEM AND METHOD FOR IMAGE PROCESSING USING MOSAIC TECHNIQUES

(71) Applicant: Boohee LEE, Busan (KR)

(72) Inventor: Boohee LEE, Busan (KR)

(21) Appl. No.: 13/191,180

(22) Filed: Jul. 26, 2011

(51) Int. Cl. H04N 7/18

(52) U.S. Cl. 348/159; 348/E07.085

(57) ABSTRACT

An image processing system and method using mosaic techniques are provided. The system includes a plurality of cameras, a mosaic image combiner combining multi-channel images from the cameras into a mosaic image, a mosaic image encoder encoding the mosaic image combined by the mosaic image combiner, a mosaic image storing unit storing therein encoded mosaic image encoded by the encoder, and a mosaic image decoder decoding the encoded mosaic image stored in the mosaic image storing unit.

### BACKGROUND OF THE INVENTION

1. Field of the Invention

The present invention relates, in general, to a system and method for image processing using mosaic techniques and, more particularly to, a system and method for image processing using mosaic techniques, in which multi-channel input images are down-sized, formed into a single mosaic image, and stored in compressed form such that it is able to be restored, whereby the mosaic image can be restored and reproduced using the less number of image restorers than that of image compressors, and when transmitted, can reduce a bandwidth of a network.

2. Description of the Related Art

With a recent sharp increase in crimes against women and children, attempts to find solutions to prevent such crimes have actively been performed. As one of the solutions, a number of close-circuit televisions (CCTVs) for security have being mounted in diverse sites for the purpose of maintaining security, rather than protecting privacy. Particularly, such CCTVs are being widely used in sites, such as a large parking lot, in order to protect women and children and secure evidence on the scene of an accident or crime.

Further, for example, while legislation is conducted in order to effectively cope with the threat from maritime terrorism or pirates against international maritime security, it is difficult to mount proper CCTVs in the ships because by the nature of ships, wiring of the CCTVs is complex to mount, and lay days of ships is very short so that there is no sufficient time to mount the CCTVs.

Thus, under such situation, the performance of a digital video recorder for compressing and restoring images of CCTVs is acquiring greater importance. However, a conventional multi-channel digital video recorder has a problem in that if it has to reproduce or search all of images at a time, an encoder compressing the images and a decoder restoring the images have the same number of units.

Meanwhile, in case of multi-channel image, when all images are intended to be restored and displayed on a screen, the images should be down-sized in order to display them because the images are mostly larger than the size of a monitor. Particularly, as a demand for storing high definition images increases, a multi-channel image system accordingly has a problem in that a hardware constituting the encoder and decoder becomes larger and complicated. Further, in order to transmit multi-channel high definition images, a wide range of bandwidth is required.

FIG. 1 shows a construction diagram of a conventional 9-channel image system.

As shown in FIG. 1, a 9-channel digital video recorder needs 9 encoders and 9 decoders for compression and restoration of images. Like this, in addition to the complicated system following the increased channels, excessive load occurs when transmitting images using a network.

### SUMMARY OF THE INVENTION

Accordingly, the present invention has been made keeping in mind the above problems occurring in the related art, and the present invention intends to propose a system and method for image processing using mosaic techniques, by which instead of all multi-channel images, only a single mosaic image is restored, so that devices and process for restoration is reduced to obtain an economical multi-channel digital video recorder, and upon transmission, load applied to a network is reduced, thereby ensuring efficient transmission.

In order to achieve the above object, according to one aspect of the present invention, there is provided an image processing system using mosaic techniques, the system including: a plurality of cameras; a mosaic image combiner combining multi-channel images from the cameras into a mosaic image; a mosaic image encoder encoding the mosaic image combined by the mosaic image combiner; a mosaic image storing unit storing therein encoded mosaic image encoded by the encoder; and a mosaic image decoder decoding the encoded mosaic image stored in the mosaic image storing unit.

In an exemplary embodiment, the image processing system may further include an image encoder separately encoding the respective multi-channel images input from the cameras.

In an exemplary embodiment, the mosaic image may have the same size as that of any one of multi-channel images input from the cameras.

In accordance with another aspect of the present invention, there is provided an image processing method using mosaic techniques, the method including: (a) receiving multi-channel images at a plurality of cameras; (b) combining the multi-channel images received in the step (a) into a mosaic image having the same size as that of one of the multi-channel images; (c) encoding the mosaic image combined in the step (b); (d) storing the encoded mosaic image encoded in the step (c), and (e) decoding the encoded mosaic image stored in the step (d).

In an exemplary embodiment, when the multi-channel images are needed to be transmitted, instead of the multi-channel images, the mosaic image is transmitted.

As set forth above, the multi-channel images input from the plurality of cameras are combined into a single mosaic image, followed by repeating encoding, storing, and decoding of the mosaic image, so that instead of all the multi-channel images, only the single mosaic image can be restored, thereby reducing the number of devices and processes for restoration and obtaining an economical multi-channel video recorder.

Further, when it is required to remotely check the multi-channel images over a network, it is sufficient to transmit only the single mosaic image, instead of all the multi-channel images, thereby reducing load applied to the network and efficiently performing image transmission.

### BRIEF DESCRIPTION OF THE DRAWINGS

The above and other objects, features and advantages of the present invention will be more clearly understood from the following detailed description when taken in conjunction with the accompanying drawings, in which:

FIG. 1 is a construction diagram of a conventional 9-channel image system; and

FIG. 2 is a construction diagram of an image processing system using mosaic techniques according to an embodiment of the present invention.

### DETAILED DESCRIPTION OF THE INVENTION

Reference will now be made in greater detail to a preferred embodiment of the invention, an example of which is illustrated in the accompanying drawings. The description and drawings are provided for only illustrative purposes, so the scope of the present invention is not limited thereto. Further, known constructions and functions that may make the present invention ambiguous will be omitted from the description. Further, while preferred embodiments will be described below, the technical scope of the present invention is not limited or restricted thereto, but may vary in diverse forms by the skilled persons in the art.

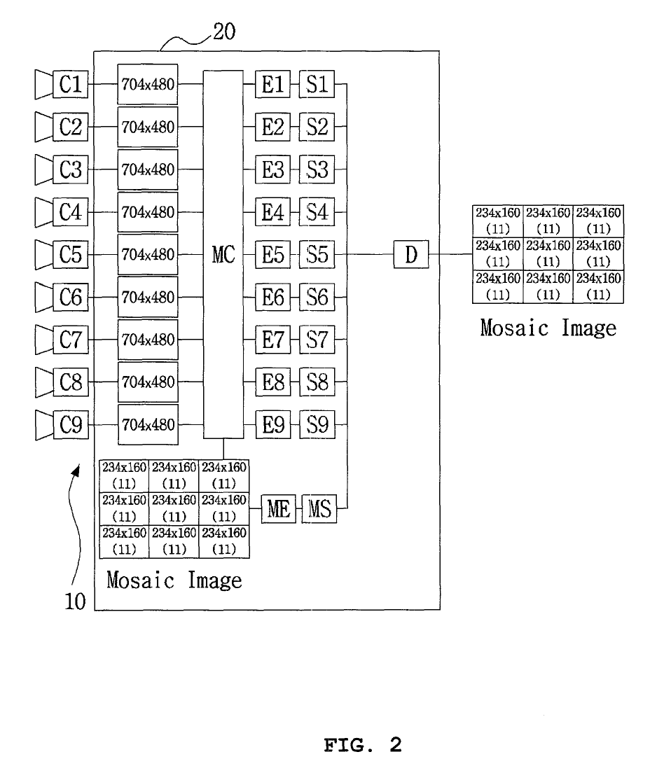

FIG. 2 is a construction diagram of an image processing system using mosaic techniques according to an embodiment of the present invention. In FIG. 2, a 9-channel image processing system is illustrated as an example of the image processing system according to the present invention.

The image processing system using mosaic techniques includes cameras 10 and an image processor 20 as shown in FIG. 2. In FIG. 2, a transmission network is omitted.

The camera 10 is a device that converts an image into an electric signal, and consists of total 9 units C1 to C9 if it comprises 9 channels.

The image processor 20 serves to combine image signals input from the cameras 10 into a mosaic image, encode the same, store the encoded, and decode the stored. For these functions, the image processor 20 includes a mosaic combiner MC, a mosaic encoder ME, a mosaic image storing unit MS, and a decoder D.

Since if only a mosaic image is encoded and then restored, a resolution of the image can be degraded, additionally, individual image encoders E1 to E9 may be selectively provided which individually encode images input from the respective cameras C1 to C9, and thus image storing units may also be selectively provided which store individually encoded images.

If the respective size of 9-channel images input from the cameras 10 is 704×480, the mosaic combiner MC receives the 9 images and converts the same into a single mosaic image of unit size of an image. Thus, since the size of the mosaic image is the same as that of an original image input from the respective camera, in order to decode the mosaic image, one encoder and one restoring unit are merely required, thereby providing the whole 9-channel images.

Here, as shown in FIG. 2, the mosaic image consists of 9 unit images that are combined together, and the size of the unit image amounts to approximately 234×160. Here, the size of an image is not limited to a specified resolution, and the embodiment is provided to have general size by way of an example.

The mosaic encoder ME serves to encode the mosaic image converted by the mosaic combiner MC, and the mosaic storing unit MS serves to store the encoded by the mosaic encoder ME. It is of course that the mosaic encoder ME and the mosaic storing unit MS may be integrally formed with each other.

The decoder D serves to decode the encoded image that is encoded by the mosaic encoder ME and is stored in the mosaic storing unit MS, thereby obtaining a mosaic image similar to an original mosaic image before being decoded.

In addition, in order to realize more distinct image quality, the decoder D can decode the individual encoded images which are encoded by the respective encoders E1 to E9 and are stored in the storing units S1 to S9, thereby acquiring an image similar to an original individual image. This may be performed in a selective manner. That is, if for reproduction and transmission, an image through a channel is intended to be seen after being magnified, an image through any one channel is reproduced or transmitted, so that an image quality is not degraded and the bandwidth of a network is not increased.

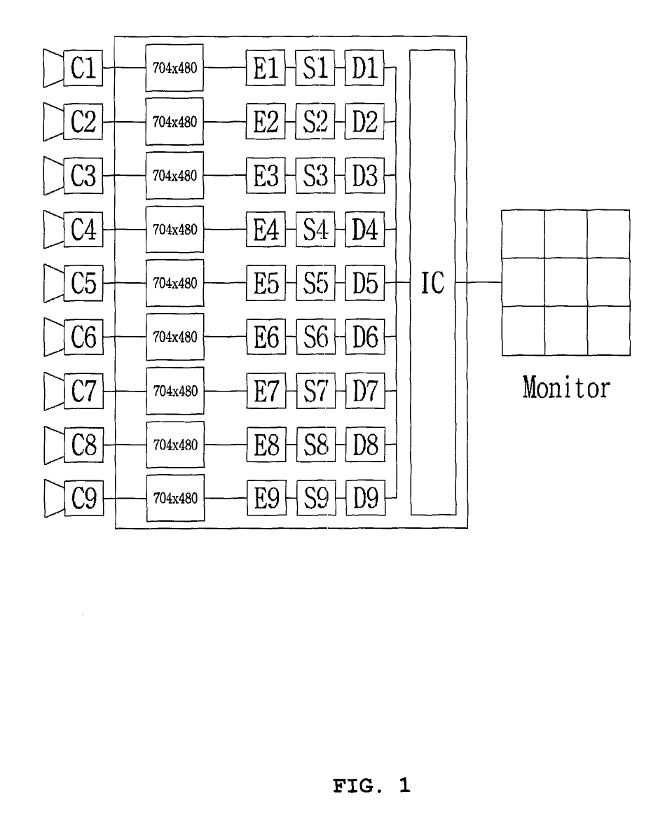

Referring to FIG. 1, a conventional 9-channel image processing system includes 9 encoders, 9 storing units, 9 decoders, and an image combiner, so that it consists of total 28 devices. Here, the combiner is a device that if it controls 9-channel images, is required to display all the 9-channel images onto a single monitor.

Referring to FIG. 2, the 9-channel image processing system includes 10 encoders (9 individual encoders and a mosaic encoder), 10 storing units (9 individual storing units and a mosaic storing unit), an image restoring unit, and a mosaic combiner), so that it consists of total 22 devices.

Comparing to the conventional 9-channel image processing system shown in FIG. 1, the 9-channel image processing system of the invention also has to include a mosaic combiner MC, a mosaic encoder ME, and an image storing unit MS. However, total 8 image restoring units can be resultantly reduced, so that the whole construction can be made simple.

In the meantime, in case that multi channel images are intended to see via a network, in order to transmit all of the multi-channel images, a bandwidth proportional to the number of channels is required. However, since if a mosaic image is used, it is sufficient that only a mosaic image through one channel is transmitted without transmitting all the multi-channel, so that network load is reduced and the transmission can be efficiently performed.

For reference, in case of a 4-channel digital video recorder, a conventional image processing system requires 4 encoders and 4 restoring units, while the image processing system using the mosaic techniques according to the present invention only requires 5 encoders (4 individual encoders and one mosaic encoder) and one image restoring unit.

In addition, in case of a 16-channel digital video recorder, a conventional image processing system requires 16 encoders and 16 restoring units, while the image processing system using the mosaic techniques according to the present invention only requires 17 encoders (16 individual encoders and one mosaic encoder) and one image restoring unit.

Next, an image processing method using mosaic techniques according to the present invention will now be described.

The image processing method includes image input, mosaic combination, mosaic encoding, mosaic storage, and mosaic restoration.

The image input is a process that receives multi-channel images from the plurality of cameras.

The mosaic combination is a process that combines the multi-channel images, which was input in the image input, into a mosaic image. Here, the size of the mosaic image is the same as that of an original image.

The mosaic encoding is a process that encodes the mosaic image that is obtained in the mosaic combination.

The mosaic storage is a process that stores the mosaic image which is encoded in the mosaic encoding.

The image restoration is a process that decodes the mosaic image stored in the mosaic storage, and thus makes an image similar to the original mosaic image.

Here, selective encoding in which the respective multi-channel images input in the image input, and individual storage in which the respective individual images encoded in the encoding process are stored can be selectively performed.

Thereby, only the mosaic image is restored without individually restoring the respective multi-channel images, the number of devices for decoding can be considerably reduced, and the process and time taken in the restoration process can be reduced, so that an economical digital video recorder can be obtained.

As described before, the present invention can be widely adapted to a field of image processing of a multi-channel digital video recorder.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. An image processing system using mosaic techniques, the system comprising:
a plurality of cameras;
a mosaic image combiner combining multi-channel images from the cameras into a mosaic image;
a mosaic image encoder encoding the mosaic image combined by the mosaic image combiner;
a mosaic image storing unit storing therein encoded mosaic image encoded by the encoder; and
a mosaic image decoder decoding the encoded mosaic image stored in the mosaic image storing unit.

2. The image processing system of claim 1, further comprising an image encoder separately encoding the respective multi-channel images input from the cameras.

3. The image processing system of claim 1, wherein the mosaic image has the same size as that of any one of multi-channel images input from the cameras.

4. An image processing method using mosaic techniques, the method comprising:
(a) receiving multi-channel images at a plurality of cameras;
(b) combining the multi-channel images received in the step (a) into a mosaic image having the same size as that of one of the multi-channel images;
(c) encoding the mosaic image combined in the step (b);
(d) storing the encoded mosaic image encoded in the step (c), and
(e) decoding the encoded mosaic image stored in the step (d).

5. The image processing method of claim 4, wherein when the multi-channel images are needed to be transmitted, instead of the multi-channel images, the mosaic image is transmitted.
